(19) United States
(12) Patent Application Publication
(10) Pub. No.: US 2006/0084345 A1
(43) Pub. Date: Apr. 20, 2006

(54) Composite non-woven wiping/scrubbing fabric and method of manufacturing the same

(76) Inventor: Michael Kann, Taipei (TW)

Correspondence Address: Ladas & Parry, 26 West 61st Street, New York, NY, 10023, US

(21) Appl. No.: 11/032,656

(22) Filed: Jan. 10, 2005

(30) Foreign Application Priority Data
Oct. 15, 2004 (TW) 093131440

(51) Int. Cl. B32B 3/06; B32B 5/26; B32B 9/00

(52) U.S. Cl. 442/382; 442/401; 442/389; 442/366; 428/102

(57) ABSTRACT

A composite non-woven wiping/scrubbing fabric, comprising a spunbond non-woven fabric and a fiber quilted layer, wherein the spunbond non-woven fabric is combined with the fiber quilted layer by stitch-bonding, and serves as the main backing of the wiping fabric with the softness, bulkiness and excellent absorbency properties of the staple fiber (e.g. rayon) of the fiber quilted layer, and the spunbond non-woven fabric is used as the scraping clean surface, especially as a material for wet scraping cleaning with its high structural strength and tenacity and the characteristics of the concavo-convex continuous creased surface resulted from stitch-bonding. This invention also relates to a method for manufacturing a composite non-woven wiping/scrubbing fabric, said method mainly comprising a step in the process of stitch-bonding non-woven fabric, wherein before stitching up the fiber quilted layer, a spunbond non-woven fabric is laid on and incorporated into the fiber quilted layer, stitched up with the fiber quilted layer so that they are bonded together. The major advantage of the process is that a spunbond non-woven fabric can be combined with fiber quilted layer by directly applying the traditional process of stitch-bonding non-woven fabric without additional complicated equipment or off-line processing, therefore reducing efforts, time and cost in manufacture.

### BACKGROUND OF THE INVENTION

1. Field of the Invention

The present invention relates to a composite non-woven wiping/scrubbing fabric.

2. Description of Related Art

In general, during the manufacture of non-woven fabrics, the fiber cotton lump, for example, rayon lump, firstly goes through the processes of cotton opening, scotching, carding, quilting and the like, and is laid into a loosen web layer with a conveying belt, and then parts of the web layer are combined firmly by hydroentangling, needle punching, high frequency thermal bonding, adhesive bonding or stitch-bonding and the like, to produce non-woven fabrics.

Typical non-woven fabric is made of staple fabric, since it is made from hydrophilic staple fibers in loosened form and therefore has superior water absorbency. However, the relatively short fibers result in weak cohesion between fibers and poor tensile strength, and once impregnated in water, the strength of the fibers will decrease significantly, thus lacking water-resistance and easily damageable. Said non-woven fabric can perform very well if applied to dry cleaning operation, for example car waxing. Though said non-woven fabric has a good water absorbency to absorb water and mop up articles, when it is applied to wet scrubbing, the strength thereof would decrease significantly upon water impregnation, and is easily damageable. Therefore, it is not suitable for wet scrubbing operation, such as car washing, dish washing and the like.

Continuous filament non-woven fabric, also known as spunbond non-woven fabric, is typically manufactured by spreading randomly and roll bonding relatively long hydrophobic fibers, such as nylon fiber, polyester fiber and the like, characterized by high structural strength, superior water and air permeability, strong water-resistance, low water absorbency as well as its thin and non-depilation property. Though such non-woven fabrics are water-resistant and their structural strength will not significantly decrease when impregnated in water, they lack water absorbency and the material is so thin that when applied to wet scrubbing, it is difficult to accumulate and retain water and detergent in the spunbond non-woven fabric per se, and therefore does not work well for wet scrubbing. In addition, since spunbond non-woven fabric has poor water absorbency and flat surface, it is not effective for wiping up dirt. Though the spunbond non-woven fabrics are water-resistant and their structural strength will not decrease significantly upon water impregnation, they lack water absorbency, and thus cannot be applied to wet scrubbing or wiping.

Non-woven fabric made by firmly bonding part of fibers of the fiber layer through a stitch-bonding process is typically referred to as “stitch-bonding non-woven fabric”. FIG. 1 illustrates a conventional manufacturing process of the stitch-bonding non-woven fabric, which mainly comprises laying the fiber cotton lumps into a plurality of fiber quilted layers through the steps of opening, scrubbing, carding, and quilting and the like, and feeding them into a model MALIMO™ Maliwatt stitch-bonding machine, machine sewing the sutures intimately to such fiber quilted layers with multiple rows of needles so as to have the fiber quilted layers stitchbonded together to have a higher strength. Though said stitchbonding non-woven fabric has a higher strength for the compact stitch-bonding with sutures, the surface is still plain and the fiber staples of the fiber quilted layers become softer after impregnated in water, resulting in a hardly satisfactory scraping effect in the wet scrubbing operation.

### SUMMARY OF THE INVENTION

Accordingly, an object of the present invention is to provide a composite non-woven wiping/scrubbing fabric, which has high water absorbency, retains sufficient strength after impregnated in water, has the surface formed with an uneven and bulgy scraping conformation, and is particularly useful for wet scrubbing and wiping operation. The composite non-woven wiping/scrubbing fabric, according to this invention, is mainly comprised of a staple fiber quilted layer having a main part of bulky backing formed by laying the staple fiber uniformly and loosely; a spunbond non-woven fabric laid onto the staple fiber quilted layer; wherein the staple fiber quilted layer and the spunbond non-woven fabric are combined by stitch-bonding.

A further object of the present invention is to provide a method for manufacturing a composite non-woven wiping/scrubbing fabric, wherein a spunbond non-woven fabric can be combined with a fiber quilted layer by directly applying the traditional process of stitch-bonding non-woven fabric without additional complicated equipment or off-line processing, therefore reducing efforts, time and cost in manufacturing; said method comprising the following steps:
(a) providing a staple fiber quilted layer laid on a conveying belt;
(b) providing a spunbonding non-woven fabric laid on the staple fiber quilted layer;
(c) sewing the spunbonding non-woven fabric and the fiber quilted layer together with sutures by a stitch bonding machine; and
(d) winding the spunbonding non-woven fabric and the fiber quilted layer into a roll after finishing the stitchbonding.

Additional objects, advantages, construction, and features of the present invention will become apparent from the following description and the appended claims, taken in conjunction with the accompanying drawings.

### BRIEF DESCRIPTION OF THE DRAWINGS

FIG. 1 is a schematic flow chart of a conventional manufacturing process of stitch-bonding non-woven fabric;

FIG. 2 is a schematically perspective view of the composite non-woven wiping/scrubbing fabric according to the first embodiment of the invention;

FIG. 3 is a sectional structural schematic view of the composite non-woven wiping/scrubbing fabric according to the first embodiment of the invention;

FIG. 4 is a sectional structural schematic view of the composite non-woven wiping/scrubbing fabric of the second embodiment of the invention;

FIG. 5 is a manufacturing flow chart of the composite non-woven wiping/scrubbing fabric of the invention; and

FIG. 6 is a schematically sectional operational view of manufacturing the composite non-woven wiping/scrubbing fabric of the invention.

### PREFERRED EMBODIMENT OF THE PRESENT INVENTION

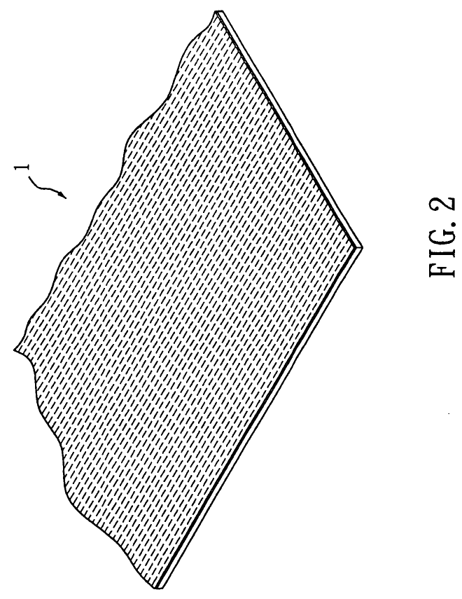

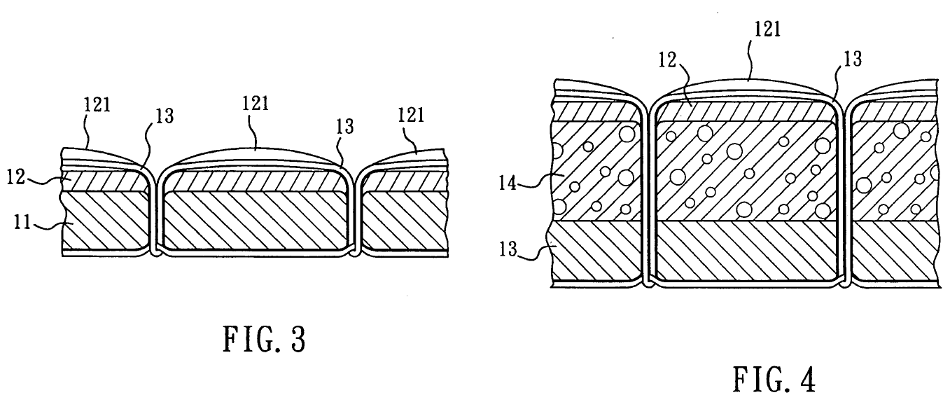

As illustrated in FIGS. 2 and 3, the composite non-woven wiping/scrubbing fabric (1) according to the first preferred embodiment of the present invention mainly comprises a staple fiber quilted layer (11) which is the main part of the bulky backing formed by laying the short or staple fibers uniformly and loosely, having a first face (upper face) and a second face (lower face) opposite to the first face; a spunbond non-woven fabric (12) laid down on the upper face of the staple fiber quilted layer (11); wherein the staple fiber quilted layer (11) and the spunbond non-woven fabric (12) are integrated by stitchbonding with the sutures (13) passing therethrough. When the staple fiber quilted layer (11) and the spunbond non-woven fabric (12) are combined via the sutures (13) by stitch-bonding, multiple densely distributed scraping humps (121) are formed on the surface of the spunbond non-woven fabric (12) by tightening of the sutures (13), since the fiber quilted layer (11) is bulky and soft, and the spunbond non-woven fabric (12) is made of coarse and tenacious fibers.

Since the spunbond non-woven fabric (12) is made of bonding coarse, tenacious, water-resistant long fibers, and the structural strength is not influenced by water impregnation, when the spunbond non-woven fabric (12) is sewed onto the fiber quilted layer (11) to form a scraping surface, the bulky and soft fiber quilted layer (11) is completely covered by the spunbond non-woven fabric (12), which can provide sufficient structural strength to prevent the strength of the composite non-woven wiping/scrubbing fabric (1) from decreasing upon water impregnation; and can further form a scraping surface suitable for wet scrubbing operation on the surface of composite non-woven wiping/scrubbing fabric (1). The plurality of evenly distributed scraping humps (121) formed on the scraping surface of the spunbonding non-woven fabric (12) allow the scraping surface of the composite non-woven wiping/scrubbing fabric to form a rugged surface and then form a scraping surface having better scraping effect on the coarse, tenacious and water-resistant long fibers of the spunbond non-woven fabric (12). It is especially suitable for scraping and scrubbing obstinate dirt and grease stain which is highly adhesive and tacky and difficult to remove, such as bathing, car washing, dish washing, floor wiping and dense grease stain wiping.

The staple fiber quilted layer (11) under the spunbond non-woven fabric (12) can firstly increase the overall thickness and soft texture of the composite non-woven wiping/scrubbing fabric (1), and may be suitable for absorbing and accumulating the cleansers (such as suds, dish detergent and other liquid detergents) therein for having the water absorbency. It is convenient for long-time scrubbing without the need of adding more detergent to the composite non-woven wiping/scrubbing fabric (1) repeatedly.

The staple fiber quilted layer (11) also becomes more sturdy and has a higher structural strength after reinforcement by stitching the sutures (13). Because the staple fiber quilted layer (11) is made of soft and water-absorbent staple fiber and forms a lower surface of the composite non-woven wiping/scrubbing fabric (1), it forms a surface suitable for wiping an article that needs to avoid scuffing.

FIG. 4 shows the second embodiment of the composite non-woven wiping/scrubbing fabric (1) according to the invention, which is different from the first embodiment mainly in that a foam layer (14) is laid between the staple fiber quilted layer (11) and the spunbond non-woven fabric (12). The foam layer (14) can be made of sponge, foam or other porous foam absorbing material. The foam layer (14) laid between the staple fiber quilted layer (11) and the spunbond non-woven fabric (12) can be used to significantly increase the overall thickness and handling texture of the composite non-woven wiping/scrubbing fabric (1), and may further significantly increase the overall water absorbency and cleanser adsorption and retaining effect of the composite non-woven wiping/scrubbing fabric (1), and enable said fabric (1) to be wrung out. The thickness of the foam layer (14) may vary according to actual requirements.

The composite non-woven wiping/scrubbing fabric (1) can also be provided with an additional spunbond non-woven fabric (not shown) at the lower surface of the staple fiber quilted layer (11), which allows the upper and lower surfaces of the composite non-woven wiping/scrubbing fabric (1) to have a structure with the spunbond non-woven fabric (12), particularly directed to the double face-structured composite non-woven wiping/scrubbing fabric for wet wiping hard grease stain and obstinate dirt.

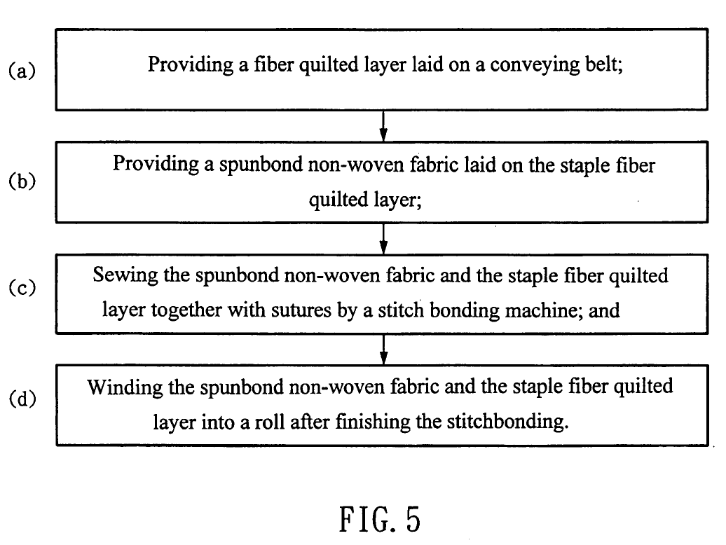

As shown in FIG. 5, the method for manufacturing a composite non-woven wiping/scrubbing fabric according to the present invention comprises mainly the following steps:
(a) providing a staple fiber quilted layer laid on a conveying belt;
(b) providing a spunbonding non-woven fabric laid on the staple fiber quilted layer;
(c) sewing the spunbonding non-woven fabric and the fiber quilted layer together with sutures by a stitch bonding machine; and
(d) winding the spunbonding non-woven fabric and the fiber quilted layer into a roll after finishing the stitch-bonding; wherein the staple fiber quilted layer laid on the conveying belt may either be a raw material provided by a staple fiber lump slackened and carded with a carding machine, or a prefabricated staple fiber quilted layer. The staple fiber laid into staple fiber quilted layer can be rayon or polyester fiber.

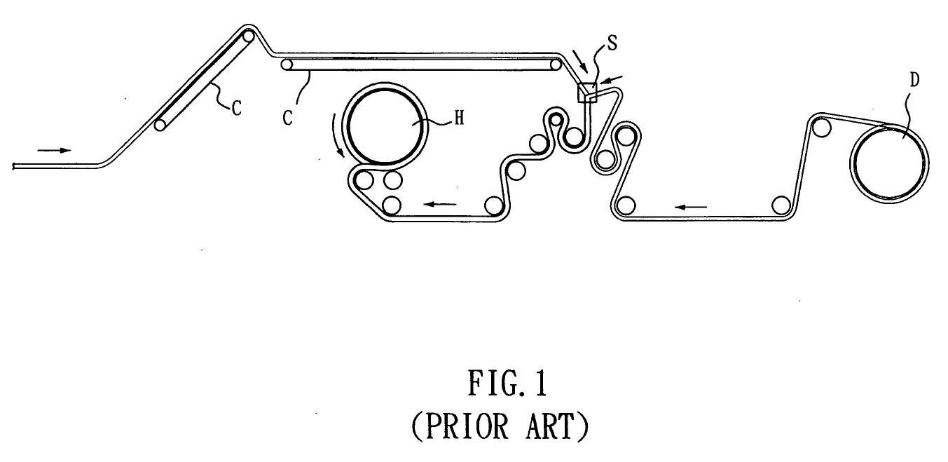

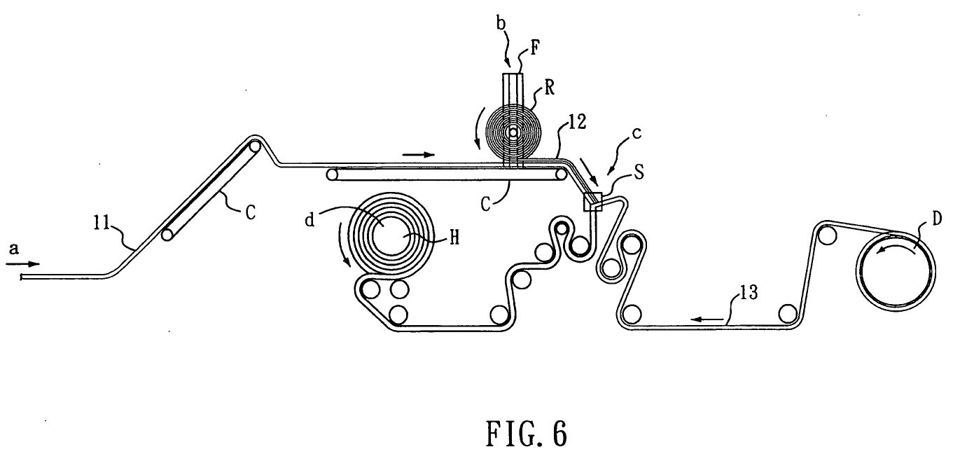

Further as shown in FIG. 6, the method for manufacturing a composite non-woven wiping/scrubbing fabric according to the present invention is mainly characterized in that it can be readily and easily applied to the process and device for the conventional stitch-bonding non-woven fabric (e.g., conventional MALIMO™ Maliwatt type stitch-bonding machine) shown in FIG. 1, without adding complicated equipment and process or off-line processing.

As shown in FIG. 6, the present invention primarily adds a spunbond non-woven fabric roll (R) to the conventional process of stitch-bonding non-woven fabric as shown in FIG. 1, in order to feed and lay the spunbond non-woven fabric on the staple fiber quilted layer before the stitch bonding machine (S) comes into operation, so that the spunbond non-woven fabric is combined with the staple fiber quilted layer during stitch bonding.

As shown in FIGS. 5 and 6, according to the method for manufacturing the composite non-woven wiping/scrubbing fabric of the present invention, a staple fiber quilted layer (11) is firstly laid onto a conveying belt (C) through which it is fed towards a stitch bonding machine (S). A spunbonding non-woven fabric roll (R) is provided in the front of the stitch bonding machine (S) to lay a spunbond non-woven fabric (12) on the fiber quilted layer (11) before the stitch bonding machine (S) start to work, and the stitch bonding machine (S) sews the fiber quilted layer (11) and the spunbond non-woven fabric (12) together. The stitch-bonding machine (S) provides a plurality of sutures (13) offered by a suture roll (D) to at least one row of stitchers (not shown) arranged closely to conduct the seam-sewing work (the related techniques are well known in the art and thus are not described herein).

The spunbond non-woven fabric roll (R) is a winding drum with a spunbond non-woven fabric (12) provided thereon. The spunbond non-woven fabric roll (R) is put up between two upright roll frames (F). These two upright roll frames (F) form an upright groove (not indicated), which can encompass the two ends of the spunbond non-woven fabric roll (R), and drop automatically as the radius of the spunbond non-woven fabric roll (R) decreases gradually due to the consumption of raw materials, so that the spunbonding non-woven fabric (12) is laid onto the staple fiber quilted layer (11) in a more fit manner.

The staple fiber quilted layer (11) and spunbonding non-woven fabric (12) combined by the stitch bonding machine (S) are delivered to a roll of finished product (H) through several groups of rollers (not indicated) and collected by winding.

According to the manufacturing method of the invention, it may further comprise a step (a-1) between steps (a) and (b) of laying a foam layer (not shown) between the staple fiber quilted layer and the spunbond non-woven fabric. That is, before the stitch bonding machine (S) starts to work, a foam layer (e.g. sponge, foam, or other similar porous foaming absorbent material) having an appropriate thickness is laid between the staple fiber quilted layer and the spunbond non-woven fabric, so that the foam layer is sewn up in integration between the staple fiber quilted layer and the spunbonding non-woven fabric.

After the spunbond non-woven fabric (12) laid on the staple fiber quilted layer (11) passes through the stitch bonding machine to stitch the spunbond non-woven fabric (12) and the fiber quilted layer (11) together, multiple scraping humps (121) are formed on the surface of the spunbond non-woven fabric (12), as shown in FIG. 3 or 4.

According to the manufacturing method of the invention, the conventional process and machine for stitch-bonding non-woven fabric can be utilized without further adding complicated equipment or further off-line processing to sew a spunbonding non-woven fabric and a staple fiber quilted layer together by sutures, and to make a water-resistant non-woven wiping fabric with an excellent, improved wet wiping effect and a structure useful for scraping obstinate dirt and grease stain.

The above-described embodiment of the present invention is intended to be illustrative only. Numerous alternative embodiments may be devised by those skilled in the art without departing from the scope of the following claims.

What is claimed is:

1. A composite non-woven wiping/scrubbing fabric, comprising:
a staple fiber quilted layer, uniformly and loosely laid with short fibers as the main part of bulky backing, having a first surface and a second surface relative to the first surface;
a spunbonding non-woven fabric laid on the first surface of the staple fiber quilted layer;
wherein the staple fiber quilted layer and the spunbonding non-woven fabric are combined by stitch-bonding the sutures through them.

2. The composite non-woven wiping/scrubbing fabric according to claim 1, wherein said staple fiber quilted layer is formed by uniformly and loosely laying the staples fibers such as rayon or polyester fiber and the like.

3. The composite non-woven wiping/scrubbing fabric according to claim 1, wherein said spunbond non-woven fabric laid on the first surface of the fiber quilted layer has multiple scraping humps formed by stitchbonding the sutures thereon.

4. The composite non-woven wiping/scrubbing fabric according to claim 1, wherein a foam layer is laid between the staple fiber quilted layer and the spunbond non-woven fabric, and is also in turn combined with the staple fiber quilted layer and the spunbond non-woven fabric by stitchbonding.

5. The composite non-woven wiping/scrubbing fabric according to claim 1, wherein the second surface of the staple fiber quilted layer is laid and sewn with another said spunbond non-woven fabric.

6. A method for manufacturing a composite non-woven wiping/scrubbing fabric, comprising the following steps:
(a) Providing a fiber quilted layer laid on a conveying belt;
(b) Providing a spunbonding non-woven fabric laid on the staple fiber quilted layer;
(c) Sewing the spunbond non-woven fabric and the staple fiber quilted layer together with sutures by a stitch bonding machine; and
(d) Winding the spunbond non-woven fabric and the staple fiber quilted layer into a roll after finishing the stitchbonding.

7. The method for manufacturing a composite non-woven wiping/scrubbing fabric according to claim 6, wherein the short fibers used to lay the staple fiber quilted layer are rayon or polyester fiber.

8. The method for manufacturing a composite non-woven wiping/scrubbing fabric according to claim 6, further comprising a step (a-1) between step (a) and step (b) of laying a foam layer with an appropriate thickness between the staple fiber quilted layer and the spunbonding non-woven fabric.

9. The method for manufacturing a composite non-woven wiping/scrubbing fabric according to claim 6, wherein the staple fiber quilted layer laid on the conveying belt is obtained by slakening and carding a staple fiber cotton lump with a cotton carding machine.

10. The method for manufacturing a composite non-woven wiping/scrubbing fabric according to claim 6, wherein after the spunbond on-woven fabric laid on the staple fiber quilted layer and the staple fiber quilted layer are sewn together with sutures by a stitch bonding machine, and multiple scraping humps are formed on its surface.
